(19) United States
(12) Patent Application Publication
(10) Pub. No.: US 2008/0293290 A1
(43) Pub. Date: Nov. 27, 2008

(54) Extension Cord Using LED as Indicator Lamp

(76) Inventors: Ying-Ming Ku, Taoyuan City (TW); Chun-Mei Wu, Wuxi (CN); Zhi-Jian Li, Wuxi (CN)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/752,974

(22) Filed: May 24, 2007

(51) Int. Cl. H01R 3/00

(52) U.S. Cl. 439/490

(57) ABSTRACT

An extension cord includes a cable, a plug on an end of the cable, and a socket casing on the other end of the cable. A lighting device is mounted in the plug or the socket casing. The lighting device includes an LED electrically connected in parallel to conductive wires in the cable and a DC converting circuit electrically connected to the LED. The DC converting circuit converts an AC voltage from the plug into a DC voltage supplied to the LED for lighting the LED. Light beams emitted by the LED transmit through the plug or the socket casing to show the extension cord and to indicate on/off state of the extension cord. Another lighting device may be mounted in the other of the plug and the socket casing. An optical fiber may be mounted in the cable and lit to show the cable.

### BACKGROUND OF THE INVENTION

1. Field of the Invention

The present invention relates to an extension cord and, more particularly, to an extension cord using an LED as an indicator lamp for indicating on/off of the extension cord.

2. Description of the Related Art

Conventional extension cords have various specifications in length and generally include a plug on an end and a socket casing on the other end for conveying AC electricity. In use, the plug of an extension cord is coupled with a socket of an external AC power source whereas a plug of an electric appliance or the like is coupled with a socket of the socket casing such that the electric appliance can be empowered by the external AC power source through the plugs and the sockets. A user of the electric appliance is often not aware of the existence and on/off state of the extension cord. A small neon lamp is provided on the socket casing and turned on to show the extension cord and to indicate that the power is on. However, the life of the neon lamp is only about 30,000 hours, and the neon lamp can only be perceived from a short distance when used outdoors in the night. The distance of perception of the neon lamp is even shorter when used in the daytime, and perception of the neon lamp is almost impossible in foggy or snowing areas.

### SUMMARY OF THE INVENTION

An objective of the present invention is to provide an extension cord using an LED (light-emitting diode) as an indicator lamp for indicating on/off of the extension cord, allowing both indoor and outdoor use. LED has a life up to 100,000 hours and consumes little electricity. Furthermore, LED is small in size and has various colors suitable for various kinds of weather conditions and circumstances. Thus, a user can perceive the on/off state of the extension cord.

An extension cord according to the preferred teachings of the present invention includes a cable including a plurality of conductive wires and an outer coating that sheathes the conductive wires. A plug is formed on an end of the cable and includes a first insulating body and a plurality of prongs supported by the first insulating body and electrically connected to the conductive wires. A socket casing is formed on the other end of the cable and includes a second insulating body and a plurality of conductive plates mounted in the second insulating body and electrically connected to the conductive wires. A lighting device is mounted in one of the first and second insulating bodies of the plug and the socket casing. The lighting device includes a light-emitting diode (LED) electrically connected in parallel to the conductive wires and a DC converting circuit electrically connected to the LED. The DC converting circuit is adapted to convert an AC voltage from the plug into a DC voltage supplied to the LED for lighting the LED. Light beams emitted by the LED transmit through one of the plug and the socket casing to show the extension cord and to indicate on/off state of the extension cord.

In an example, the LED is embedded in a light-transmittable housing of the first insulating body of the plug.

In another example, the LED is embedded in a light-transmittable housing of the second insulating body of the socket casing.

In a further example, each of the first and second insulating bodies includes a light-transmittable housing in which an LED is embedded.

In still another example, the outer coating of the cable is light transmittable, and the cable further includes an optical fiber mounted inside the light-transmittable outer coating and electrically connected to the LED such that the optical fiber is lit by the light beams emitted from the LED to show the cable.

Other objectives, advantages, and novel features of the invention will become more apparent from the following detailed description when taken in conjunction with the accompanying drawings.

### BRIEF DESCRIPTION OF THE DRAWINGS

FIG. 1 shows a perspective view of an extension cord according to the preferred teachings of the present invention.

FIG. 2 shows an elevational view of an example of the extension cord according to the preferred teachings of the present invention, with an LED embedded in a light-transmittable plug.

FIG. 3 shows an elevational view of another example of the extension cord according to the preferred teachings of the present invention, with an LED embedded in a light-transmittable socket casing.

FIG. 4 shows an elevational view of a further example of the extension cord according to the preferred teachings of the present invention, with an LED embedded in a light-transmittable plug and with another LED embedded in a light-transmittable socket casing.

FIG. 5 shows an elevational view of still another example of the extension cord according to the preferred teachings of the present invention, with an LED embedded in a light-transmittable plug, and with an optical fiber embedded in a cable.

FIG. 6 shows an elevational view of yet another example of the extension cord according to the preferred teachings of the present invention, with an LED embedded in a light-transmittable socket casing, and with an optical fiber embedded in a cable.

### DETAILED DESCRIPTION OF THE PREFERRED EMBODIMENTS

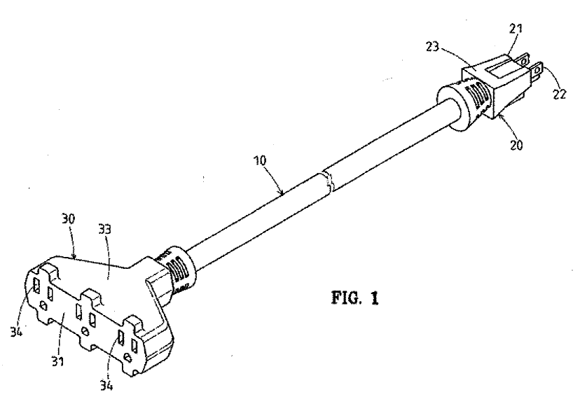

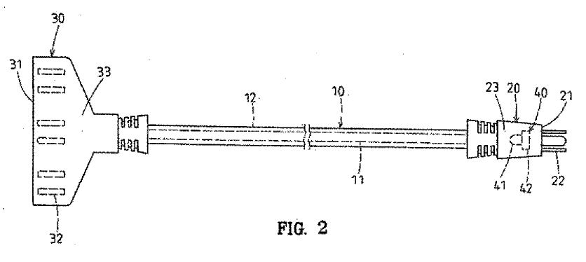

With reference to FIGS. 1-4, an extension cord according to the preferred teachings of the present invention includes a cable 10, a plug 20 formed on an end of the power line 10, and a socket casing 30. The cable 10 includes a plurality of conductive wires 11 and an outer coating 12 that sheathes the conductive wires 11. The plug 20 includes an insulating body 21 and a plurality of prongs 22 supported by the insulating body 21 and electrically connected to the conductive wires 11. The socket casing 30 includes an insulating body 31 having a plurality of conductive plates 32 electrically connected to the conductive wires 11 of the cable 10 and a plurality of slots 34 mounted in the insulating body 31 for receiving prongs (not shown) of a plug (not shown) of an electric appliance (not shown) or the like.

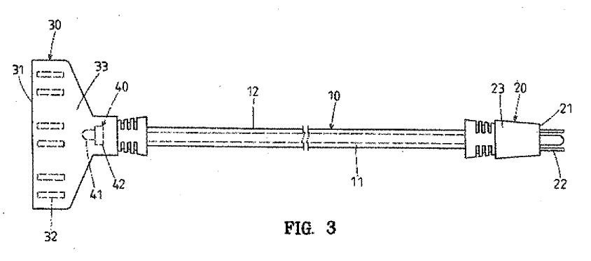

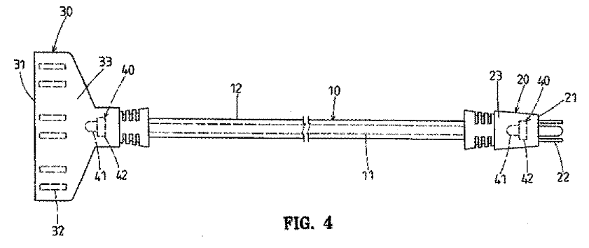

Of more importance, the extension cord according to the preferred teachings further includes a lighting device having an LED (light-emitting diode) for indicating on/off state of the extension cord. In an example shown in FIG. 1, the plug 20 is light-transmittable, and a lighting device 40 is embedded in the plug 20. The lighting device 40 includes an LED 41 and a DC converting circuit 42. The LED 41 is electrically connected in parallel to the conductive wires 11. The conductive plates 32 of the socket casing 30 become conductive when the plug 20 is coupled to an external AC power source (not shown). This allows use of an electric appliance whose plug is inserted into the slots 34 of the socket casing 30. The DC converting circuit 42 converts an AC voltage from the external AC power source into a DC voltage for use by the LED 41. Thus, the LED 41 is lit to indicate that the extension cord is on while showing the position of the extension cord. It can be appreciated that the insulating body 21 of the plug 20 includes a light-transmittable housing 23 through which light beams emitted from the LED 41 transmits outward. In another example shown in FIG. 3, the insulating body 31 of the socket casing 30 has a light-transmittable housing 33 in which a lighting device 40 is embedded. In a further example shown in FIG. 4, a lighting device 40 is embedded in an insulating body 21 having a light-transmittable housing 23, and another lighting device 40 is embedded in a socket casing 30 having a light-transmittable housing 33.

The LED 41 can be constantly lit or flicker according to product needs. Furthermore, the LED 41 may emit red light to increase penetrability, to avoid scattering, to enhance perceptibility, and to enhance visibility, allowing use of the extension cord in foggy or snowing areas. The LED 41 has a long life up to 100,000, consumes little electricity, and is small in size. LEDs emitting other colors would be within the skill of the art.

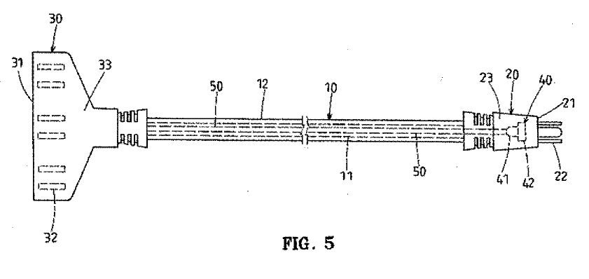

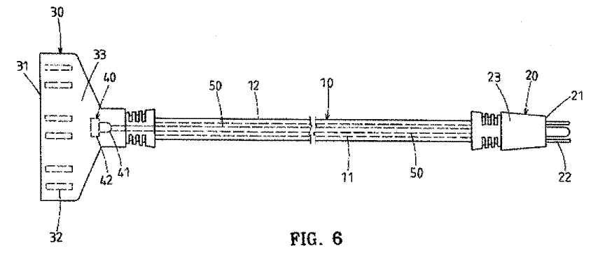

FIG. 5 shows an elevational view of still another example of the extension cord according to the preferred teachings of the present invention, wherein an LED 40 is embedded in a plug 20 having a light-transmittable housing 23, the cable 10 includes a light-transmittable outer coating 12, and one ore more optical fiber 50 are embedded in the cable 10 between the light-transmittable outer coating 12 and the conductive wire 11. The optical fiber 50 is electrically connected to a light-emitting end of the LED 41 such that the optical fiber 50 is lit by the light beams emitted from the LED 41 to thereby make the whole cable 10 conspicuous. FIG. 6 shows an elevational view of yet another example of the extension cord according to the preferred teachings of the present invention. The only difference between this example and the example of FIG. 5 is that the LED 41 is embedded in a socket casing 30 having a light-transmittable housing 33.

By embedding an LED 41 in at least one of the plug 20 and the socket casing 30, the socket extension according to the preferred teachings of the present invention can be used both indoors and outdoors. LED has a life up to 100,000 hours and consumes little electricity. Furthermore, LED is small in size and has various colors suitable for various kinds of weather conditions and circumstances. When the LED 41 is lit, it is an excellent indicator lamp such that a user can easily perceive the on/off state of the extension cord. Furthermore, the cable 10 of the extension cord can be shown by embedding an optical fiber 50 in the cable 10 and electrically connected to the LED 41.

Although specific embodiments have been illustrated and described, numerous modifications and variations arc still possible without departing from the teachings of the invention. The scope of the invention is limited by the accompanying claims.

What is claimed is:

1. An extension cord comprising:
a cable including a first end and a second end, with the cable including a plurality of conductive wires and an outer coating that sheathes the conductive wires;
a plug formed on the first end of the cable, with the plug including a first insulating body and a plurality of prongs supported by the first insulating body and electrically connected to the conductive wires;
a socket casing formed on the second end of the cable, with the socket casing including a second insulating body and a plurality of conductive plates mounted in the second insulating body and electrically connected to the conductive wires; and
a lighting device mounted in one of the first and second insulating bodies of the plug and the socket casing, with the lighting device including a light-emitting diode electrically connected in parallel to the conductive wires and a DC converting circuit electrically connected to the light-emitting diode, with the DC converting circuit being adapted to convert an AC voltage from the plug into a DC voltage supplied to the light-emitting diode for lighting the light-emitting diode, and with light beams emitted by the light-emitting diode transmitting through one of the plug and the socket casing to show the extension cord and to indicate on/off state of the extension cord.

2. The extension cord as claimed in claim 1 with the first insulating body of the plug including a light-transmittable housing in which the LED is embedded.

3. The extension cord as claimed in claim 1 with the second insulating body of the socket casing including a light-transmittable housing in which the LED is embedded.

4. The extension cord as claimed in claim 2 with the second insulating body of the socket casing including a second light-transmitting housing, and with the extension cord further comprising, in combination: a second lighting device mounted in the second light-transmittable housing, with the second lighting device including a second light-emitting diode electrically connected in parallel to the conductive wires and a second DC converting circuit electrically connected to the second light-emitting diode, with the second DC converting circuit being adapted to convert the AC voltage from the plug into a DC voltage supplied to the second light-emitting diode for lighting the second light-emitting diode, and with light beams emitted by the second light-emitting diode transmitting through the second light-transmittable housing of the socket casing to show the extension cord and to indicate the on/off state of the extension cord.

5. The extension cord as claimed in claim 1 with the outer coating of the cable being light transmittable, and with the cable further comprising an optical fiber mounted inside the light-transmittable outer coating and electrically connected to the LED such that the optical fiber is lit by the light beams emitted from the LED to show the cable.

6. The extension cord as claimed in claim 1 with the LED being controlled by the illuminating device to light constantly

7. The extension cord as claimed in claim 1 with the LED being controlled by the illuminating device to flicker.

8. The extension cord as claimed in claim 1 with the light-emitting diode emitting red light.
